(19) United States
(12) Patent Application Publication
(10) Pub. No.: US 2023/0175083 A1
(43) Pub. Date: Jun. 8, 2023

(54) Finishing method and system for tanned or synthetic hides

(71) Applicant: Todesco S.r.l., Creazzo (VI) (IT)

(72) Inventors: Paolo Todesco, Monteviale (VI) (IT); Giorgio Todesco, Creazzo (VI) (IT)

(21) Appl. No.: 17/997,914

(22) PCT Filed: May 13, 2021
(86) PCT No.: PCT/IB2021/054102

§ 371 Date: Nov. 3, 2022

(30) Foreign Application Priority Data
May 13, 2020 (IT) 102020000010873

(51) Int. Cl. C14C 11/00; C14C 15/00; C14B 1/58; C14B 7/02

(52) U.S. Cl. CPC C14C 11/003; C14B 1/58; C14B 7/02; C14C 15/00

(57) ABSTRACT

A method of processing leather, which may be a tanned or synthetic animal leather or a leather of animal origin, includes the steps of providing a leather to be processed and irradiating the leather to be processed with UV rays. A station for processing the leather includes a receiving point for the leather to be processed, a delivery point for the processed leather, a working area for housing the leather to be processed that is interposed between the receiving and delivery points, and a source of UV rays arranged at the working area.

### TECHNICAL FIELD

The present invention generally relates to the technical field of industrial processing of animal leather or leather of animal origin, and it particularly relates to a method and a line for finishing leather, whether animal, of animal origin or synthetic.

### DEFINITIONS

In the present document, the expression “hide” or “leather” is used to indicate any layer, whether it be grain, crust or sub-crust, of the leather of an animal, in particular of a bovine, but also of sheep/goats, exotic, fur, wild animals or others.

In the present document, “a leather” or “the leather” is used to indicate at least one part of the leather of a single animal, which may therefore be of any shape. For example, the leather may be whole leather, half leather, shoulders, hunch, back, hips, rear or front parts of the body.

In the present document, the expression “size of the leather” therefore is used to indicate the size of the surface area of a leather once laid on a plane.

In the present document, the expression “animal leather or leather of animal origin” is used to indicate the so-called “genuine leather”, the so-called “leatherette” or “faux leather” or other similar composite products containing animal leather.

In the present document, the expression “synthetic leather” or derivatives is used to indicate a synthetic non-animal medium or medium of animal support whose external appearance is similar to animal leather or leather of animal origin.

In the present document, the expression “providing” or derivatives thereof is used to indicate the preparation of an element of interest to a process step of interest, thus including any preventive treatment aimed at the optimal execution of the step of interest, from simple collection and possible storage to heat and/or chemical and/or physical pretreatments and the like.

### STATE OF THE ART

It is known that animal leather is subjected to several processes.

Generally, these processes are divided into three processing groups: beamhouse processing (typically: soaking, liming, depilation, skiving, splitting, decalcification, maceration and pickling), tanning and post tanning (typically: skiving, splitting, shaving, dyeing, fattening, drying, possibly staking and/or nailing, finishing, ironing, pressing and measuring).

The processes subsequent to tanning, and in particular finishing processes, therefore have the purpose of improving the aesthetic and/or product class characteristics of the leather. Generally, the finishing takes place on substantially dry leather, that is leather that has undergone a drying process, for example by means of a vacuum plant.

There are various types of finishing techniques, among which the most used is the spray technique.

A typical spray finishing line includes one or more spray booths and one or more drying tunnels.

In spray booths, mixtures of organic solvent and/or water and chemical substances suitable to confer the aforementioned aesthetic and/or product class characteristics to the leather are sprayed onto the leather. In order to cause the chemical reactions for the polymerisation of such substances and the removal of water and/or solvent, tunnels generally operate at 80° C. - 140° C.

A drawback of such processing consists in exposing the leather to high temperatures, which entails a deterioration of the collagen present in the leather, which causes a shrinking of the fibre and, therefore, both a reduction in the dimensions and a hardening of the leather.

More generally, the processing of leather at high temperatures compromises the quality of the leather itself.

Furthermore, due to the high temperatures, this processing method requires a high amount of energy and rather long treatment times, with evident repercussions in economic terms.

### SUMMARY OF THE INVENTION

An object of the present invention is to at least partly overcome the drawbacks illustrated above, by providing a leather finishing method and/or a line that is highly functional and cost-effective.

Another object of the invention is to provide a leather finishing method and/or a line that allows to obtain a high-quality product.

Another object of the invention is to provide a leather finishing method and/or a line that allows a limited or no reduction in the size of the leather during the processing.

Another object of the invention is to provide a leather processing method and/or line that is particularly fast.

Another object of the invention is to provide a leather processing method and/or line that allows to minimise the process costs.

These and other objects which will be more apparent hereinafter, are attained by a method and/or a finishing line of as described, illustrated and/or claimed herein.

The dependent claims describe advantageous embodiments of the invention.

### BRIEF DESCRIPTION OF THE DRAWINGS

Further characteristics and advantages of the invention will be more apparent in light of the detailed description of a preferred but non-exclusive embodiment of the invention, illustrated by way of non-limiting example with reference to the attached drawings, wherein:

FIGS. 1A and 1B, 2A and 2B, 3A and 3B are schematic axonometric views of some embodiments of a polymerisation station 10 in different operative steps;

FIGS. 4 to 8 are schematic axonometric views of further embodiments of the polymerisation station 10;

FIG. 9 is a schematic axonometric view of a device 100;

FIG. 10 is a schematic view of a finishing line 1.

### DETAILED DESCRIPTION OF SOME PREFERRED EMBODIMENTS

With reference to the attached figures, herein described is a method for finishing leather P, which may preferably be processed by means of a continuous finishing line 1, which may include a station S for depositing a product on the leather P and a polymerisation station 10, better described hereinafter.

Although the present description generally relates to leather, it is clear that it can be animal leather, leather of animal origin or synthetic leather without departing from the scope of protection of the attached claims.

The deposition will deposit one or more layers of product on the leather in a scattered and non-point manner. Possibly, the deposition will be carried out homogeneously.

For example, deposition may be carried out in station S by spraying with suitable guns or by means of roller machines, spreading machines or buffer machines.

In this manner, the operation for finishing the leather P will be carried out in a fast, practical and cost-effective manner.

In any case, the finishing may be carried out on the substantially dry leather P, that is leather that has undergone a drying process, for example by means of a vacuum plant.

Depending on the needs, one may process a face or both faces of the leather P.

Even though hereinafter reference will generally be made to leather P, it is clear that it is possible to process a single leather or a plurality of leathers without departing from the scope of protection of the attached claims.

Essentially, the method may comprise a step for providing the leather P and subsequent irradiation thereof with ultraviolet rays (UV rays) in a working chamber 25. Advantageously, when carrying out the irradiation step the leather P may comprise a photopolymerisable composition which can be activated by means of UV rays.

Possibly, the photopolymerisable composition may be already present on the leather P or it may be deposited thereon in the station S, for example in an amount comprised between 10 g/m² and 150 g/m².

In a preferred but non-exclusive embodiment, the photopolymerisable composition may be an aqueous solution or dispersion consisting of:
(A) at least one photopolymerisable compound;
(B) at least one photoactivating agent;
(C) possibly, at least one crosslinking agent;
(D) possibly, at least one pigmenting agent;
(E) possibly, at least one further additive.

Advantageously, the water in the aqueous solution or dispersion may be present in a percentage comprised between 10% by weight to 50% by weight with respect to the total weight of the aqueous solution or dispersion, preferably comprised between 15% by weight and 45% by weight with respect to the total weight of the aqueous solution or dispersion, and even more preferably comprised between 20% by weight and 40% by weight with respect to the total weight of the aqueous solution or dispersion.

The relatively high presence of water allows the composition to be deposited on the leather P at high speeds, preferably continuously by spraying.

For environmental reasons, the aqueous solution or dispersion may be devoid of organic solvent.

Suitably, the at least one photopolymerisable compound may be selected from: acrylates, epoxy acrylates, polyether acrylates, polyether acrylates, polyurethane acrylates, polyether, silicone, polyurethane polymers or copolymers, polyurethanes with polyether polyol, butadiene copolymers.

On the other hand, the at least one photoactivating agent may be selected from aromatic ketones, such as for example as benzophenone or 1-hydroxycyclohexyl phenyl ketone.

The presence of the at least one crosslinking agent may be particularly advantageous. If present, such at least one crosslinking agent may for example be carbodiimide or isocyanate.

Pigments for imparting the desired colouring to the leather and possibly also other additives, such as fillers, stabilisers, for example surfactants, all known to the person skilled in the art, may be suitably present.

Irradiation by means of UV rays may cause the polymerisation of the composition, so as to finish the leather P.

Such finishing may change the physical state of the leather. For example, the surface of the leather P may be prepared for a subsequent painting or for a subsequent surface treatment.

The finishing may allow to define the aesthetic and/or product class characteristics of the leather. In particular, at least one surface layer of the leather P may be processed so as to define the durability, colour and/or finish characteristics of the leather P.

Furthermore, thanks to the finishing, the leather P may have particular characteristics such as a particular texture, colour tone, waterproofing.

Thanks to the use of UV rays, there will be no need for working at high temperatures to polymerise the chemical finishing substances so as to obtain high quality leather P. Furthermore, dimensional reduction of the leather P will be limited or absent.

If necessary, during irradiation the working chamber 25 may be heated at relatively low temperatures.

Such temperature may be lower than 60° C., preferably lower than 55° C., and possibly lower than 40° C.

More particularly, such temperature may preferably be comprised between 20° C. and 50° C.

Processing at low temperatures allows to have low energy consumption. Furthermore, there is no need for particular expensive and cumbersome protections, for example thermal insulation of the polymerisation station 10, so that the latter is particularly safe.

Suitably, the leather P to be processed may be hit by UV rays for a predetermined time interval. The time interval may vary depending on the power of the UV rays and/or depending on the leather P to be processed and/or depending on the substances to be activated.

In particular, the time and/or intensity may be particularly low in the presence of a suitable activation/inhibition system. For example, the irradiation time may be less than 3 minutes. Preferably, the irradiation time may be less than 30 seconds, even more preferably about 10 seconds.

More particularly, the irradiation step may be carried out for a working time comprised between 1 sec and 60 sec, more preferably comprised between 2 sec and 45 sec and even more preferably comprised between 5 sec and 30 sec.

The method according to the present invention may be carried out continuously or discontinuously.

Advantageously, the photopolymerisable composition may be polymerised by means of a polymerisation station 10, which may comprise a working chamber 25 with a working area 11 designated to house the leather P to be processed and means 12 for loading and means 13 for unloading the leather into/from the working area 11.

The polymerisation station 10 may therefore comprise an inlet 21 and an outlet 22 to allow the loading and unloading of the leather P into/from the working area 11.

Preferably, the polymerisation station 10 may comprise a support structure 20. In particular, the latter may comprise one or more openings defining the inlet 21 and the outlet 22. Possibly, the inlet 21 and the outlet 22 may coincide.

Suitably, the polymerisation station 10 may comprise means 40 for the emission of UV rays positioned in such a way that the UV rays hit the leather P arranged in the working area 11. Preferably, the means 40 may be arranged inside the working area 11.

The means 40 may be one or more UV-ray generating devices of the per se known type. For example, UV lamps of the per se known type may be used.

Advantageously, such lamps may include a plurality of LEDs. In this manner, the costs for supplying the means 40 will be minimised.

Suitably, these LEDs may be configured to emit UV rays with a wavelength comprised between 280 nm and 400 nm. This will allow to prevent the formation of harmful gases in the working chamber 25.

In a preferred but non-exclusive embodiment, a station S for depositing the photopolymerisable composition on the leather P may be provided for upstream of the polymerisation station 10.

Advantageously, such deposition station S may include a spray booth 200 comprising a rotary turntable 210 provided with at least 12 arms 220, and preferably with a number of arms comprised between 14 and 24.

Each arm 220 may include one or more spraying guns 230.

An example of a spray booth 200 provide with 24 arms is known from Italian patent 102015000039515.

In the station S the deposition may be carried out by hand spraying, spraying with slidable guns, roller, glazing or buffer.

Suitably, a conveyor belt 29 or motor-driven rollers 29′ may be provided for the leather P so that the leather P sequentially passes first through the spray booth 200 and then through the polymerisation station 10. In this manner, the steps for depositing the photopolymerisable composition and irradiating the leather P may be carried out continuously.

In a preferred but non-exclusive embodiment, the finishing line 1 may provide for a first and a second spray booth 200, 200′ and a first and second polymerisation station 10, 10′, alternating with respect to each other.

In this manner, a first deposition - on the leather P - of a first photopolymerisable composition may be carried out in the first booth 200, which may be subsequently at least partially polymerised in the first station 10.

This will allow to create - on the leather P - a first at least partially polymerised “bottom” layer L1, suitable to prepare them for the subsequent processes.

The leather P comprising the first layer L1 may be inserted into the second booth 200′, in which a second photopolymerisable composition may be deposited above the layer L1. The latter will then be at least partially polymerised in the second station 10′.

This will allow to create a second finishing layer L2 on the layer L1.

The two photopolymerisable compositions may be different depending on the needs and characteristics to be conferred to the leather P, but they may still have the aforementioned formulation.

Possibly, as mentioned above, the polymerisation station 10 may comprise heating means 30 acting on the leather P to bring the working chamber 25 to the aforementioned temperatures with the aim of eliminating the water or the solvent.

The heating means 30 may be of different types. For example, the means 30 may be an infrared ray (IR rays) lamp, electrical resistors, steam, oil, gas or hot water heat exchangers or the like of the per se known type.

Preferably, but not exclusively, the IR lamp 30 may be arranged inside the working area 11.

The IR lamp 30 may be selectively activatable manually, for example by an operator by means of a switch, or automatically, for example following the detection of the presence of the leather P in the working area 11. Such detection may be carried out in a per se known manner by means of detection sensors.

Suitably, the IR lamp 30 may be configured so that the working temperature does not exceed a certain limit temperature.

Suitably, there may be provided for sensor means of the per se known type operatively connected to the IR lamp 30 so that the latter is automatically activated/deactivated to maintain the temperature below the limit temperature.

It is clear that the duration of the step for irradiating by means of UV lamps 40, as well as of the steps for heating by means of IR lamps 30 and the spraying of the substances to be activated, may vary depending on the needs, for example depending on the processing speed and/or the type of leather P.

The support structure 20 may comprise a support plane 23 suitable to support the leather P during use, that is during all or at least a part of the processing of the leather P.

Suitably, the working area 11 may be different in size depending on the preferences. In particular, the support plane 23 may have variable length and/or width depending on the preferences.

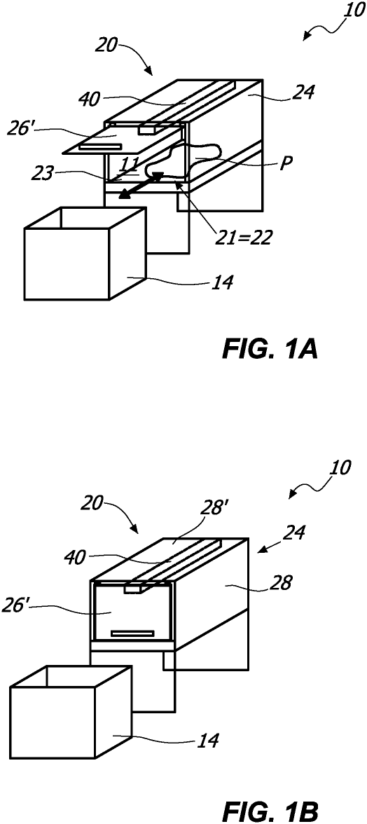

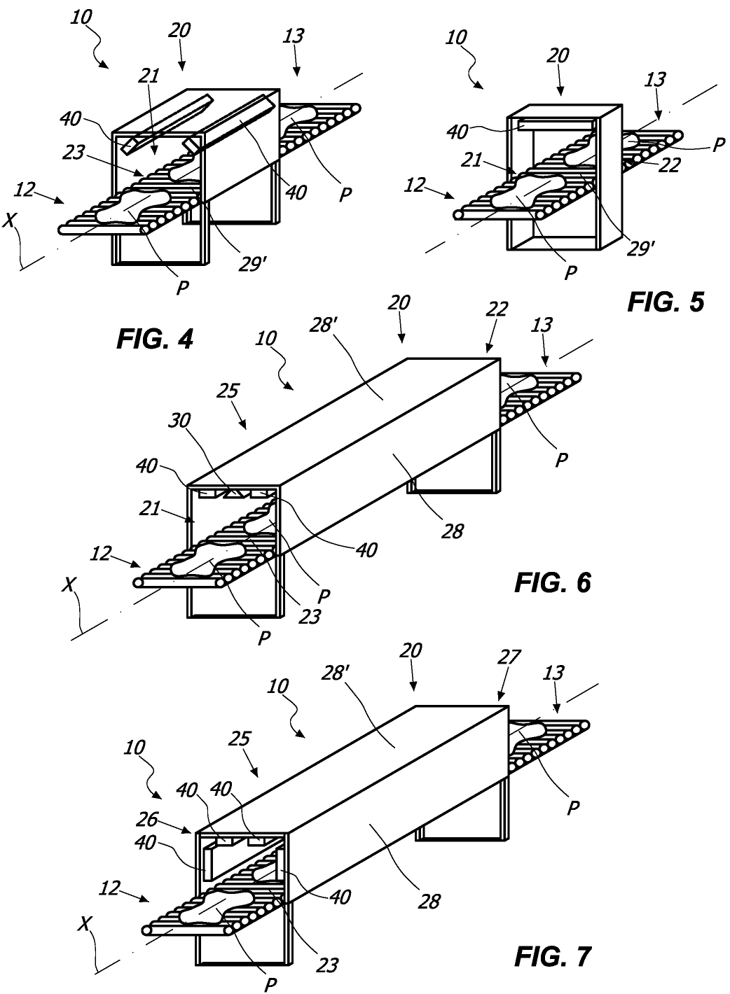

For example, as illustrated in FIGS. 1A, 1B and 4, the support plane 23 may be small in size, for example it may measure about 2 m long and about 2 m wide, so that the polymerisation station 10 allows to process a single leather P at a time. In such case, the polymerisation station 10 may have overall dimensions particularly small in size.

Possibly, as schematically illustrated in FIG. 5, the support structure 20 may be particularly small in size defining a portal overlying the leather P.

On the other hand, the support plane 23 may have a width and/or length greater than the dimensions of a single leather P. Furthermore, this will allow the polymerisation station 10 to process a plurality of leathers P simultaneously.

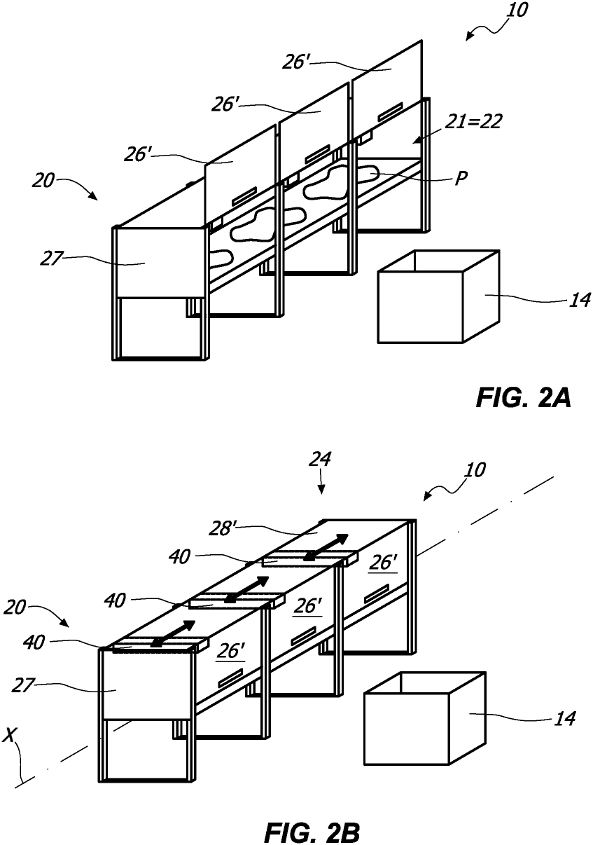

For example, as schematically illustrated in FIGS. 2A, 2B, 3, 6, 7 and 8, the support plane 23 may have a width substantially equal to the width of a leather, about 3 metres, and a variable length depending on the needs, for example about 12 m.

In this case, the support structure 20 may have a substantially longitudinal extension defining an axis X.

Suitably, means 29 for causing the advancement of the leather P in the working area 11 may be provided for. In particular, the means 29 may cause the advancement of the leather P along the work plane 23. For example, there may be provided for a conveyor belt, a plurality of planes or motor-driven rollers 29′ or the like of the per se known type. The conveyor belt or the rollers 29′ may define the work plane 23.

It is clear that the leather P may be displaced in the polymerisation station 10 in a different manner without departing from the scope of protection of the present invention. For example, the means 29 may comprise a chain system or other systems known in the industry.

According to a particular embodiment, the working area 11 may be substantially closed during use.

In particular, the working area 11 may be substantially closed during the entire processing step or only during some sections of the processing step. For example, should the processing provide for the irradiation and heating step, the working area 11 may be opened during the irradiation step and it may be closed during the heating step, or it may be closed/opened during both steps.

Suitably, the support structure 20 may comprise a cover 24 overlying the support plane 23 and cooperating with the latter to define the working area 11.

Possibly, the support structure 20 may be moveable between a closed configuration (FIGS. 1B, 2B 3B) in which the working area 11 is closed, and an open configuration (FIGS. 1A, 2A 3A) in which the working area 11 is open to allow the loading/unloading of the leather into/from the working area 11.

In a preferred but non-exclusive embodiment, the support structure 20 may substantially define a tunnel 25. The tunnel 25 may have a pair of side walls 28 and an upper wall 28′ so that the cover 24 is substantially rectangular-shaped and the working area 11 is substantially parallelepiped-shaped.

It is clear that such embodiment is not exclusive. As a matter of fact, the cover 24 may have different configurations, for example it may be substantially circular or hemispherical-shaped.

Furthermore, the cover 24 may be substantially continuous or it may comprise one or more openings, or it may have a reticular structure and it may, for example, be made by means of trestles or tubular elements.

The tunnel 25 may have the inlet 21 and the outlet 22. Suitably, panels or doors 26′ positioned at the inlet 21 and/or at the outlet 22, which may be selectively openable so as to allow the support structure 20 to pass from the open configuration to the closed configuration, may be provided for.

For example, schematically illustrated in FIGS. 1A and 1B, there may be provided for a door 26′ arranged at the inlet 21, rotatably moveable between an open position and a closed position. It is clear that the inlet 21 and the outlet 22 may coincide so as to allow both the loading and unloading of the leather P.

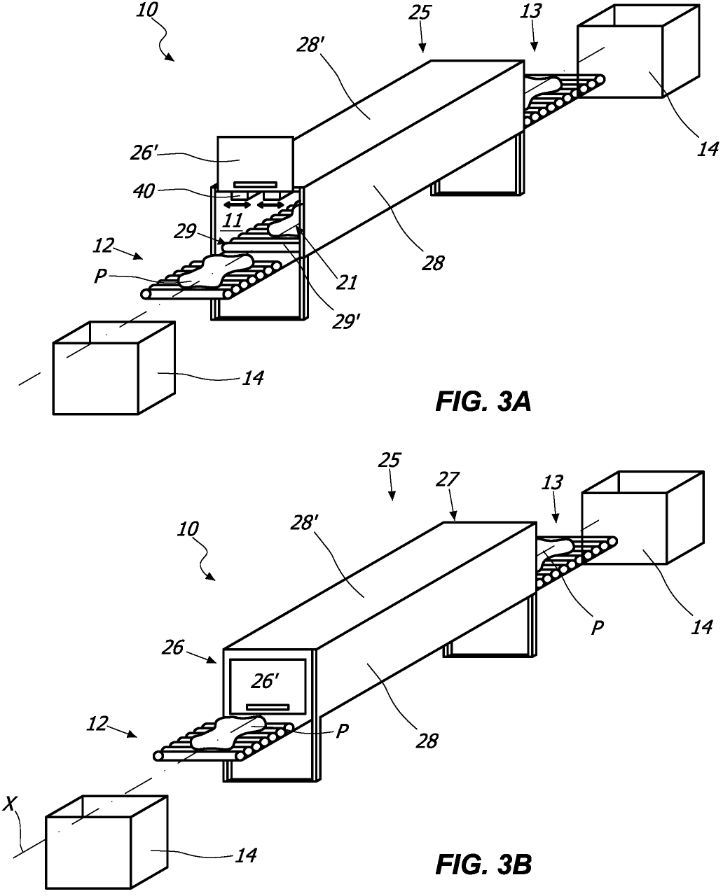

According to different embodiments, the tunnel 25 may have the inlet 21 and the outlet 22 arranged at the ends 26, 27 thereof as schematically shown in FIGS. 3A and 3B, or it may have the inlet 21 and the outlet 22 and corresponding panels 26′ arranged at the side walls of the cover 24, as schematically shown in FIGS. 2A and 2B.

In this case, the panels 26′ may be slidable. However, it is clear that such panels 26′ may be of any type.

Suitably, the advancement means 29 may cause the advancement of the leather P in the tunnel 25 between the end 26 and the end 27 thereof.

According to a different embodiment, the working area 11 may be substantially open during use. For example, schematically illustrated in FIGS. 4, 6, 7 the tunnel structure 25 may have the side walls 28 and it may be without the panels 26′, 27′ at the ends 26, 27 so that the inlet 21 and the outlet 22 are always open.

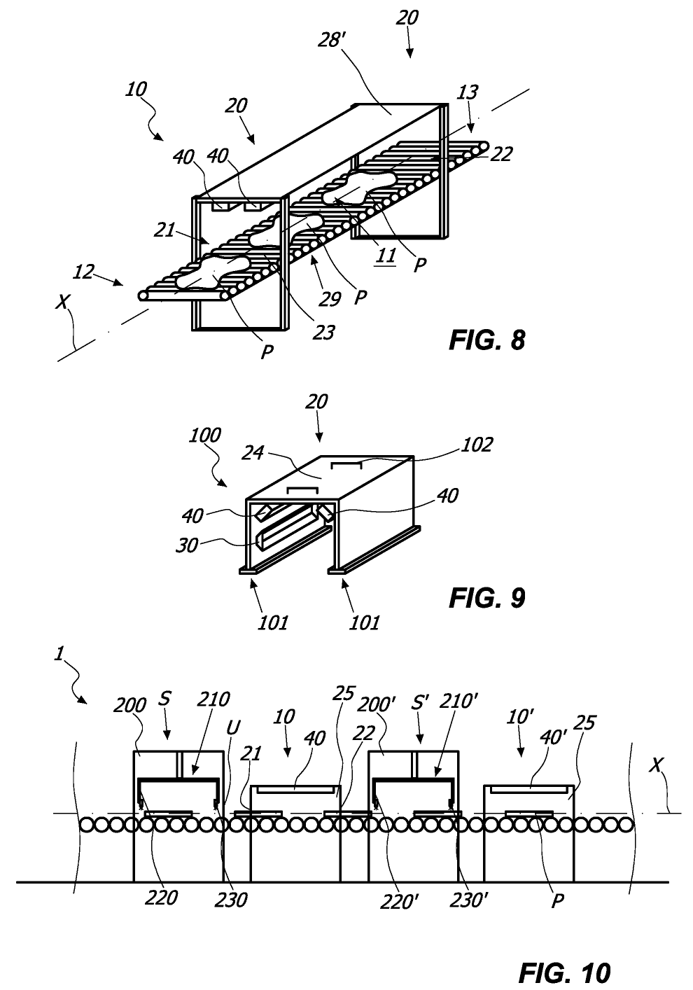

Possibly, according to a different embodiment, the support structure 25 may be without continuous side walls 28, as schematically illustrated in FIG. 8. In this case the cover 24 may be substantially discontinuous, for example it may be a tubular or reticular structure.

As mentioned above, the polymerisation station 10 may operate continuously or discontinuously.

For example, as schematically illustrated in FIGS. 1A to 3B, the processing stations may have a substantially discontinuous operation. The loading and/or unloading of the leather P may be carried out manually by an operator or automatically, for example by means of suitable loading 12 and/or unloading 13 means.

Possibly, the rollers 29′ may have a length substantially greater than the length of the support structure 20 so that the ends thereof define the loading and/or unloading 12 and 13 means.

Suitably, there may be provided for storage containers 14 arranged at the inlet 21 and/or at the outlet 22 for the leather P processed and/or to be processed.

On the other hand, according to a different embodiment, the polymerisation station 10 may have a substantially continuous operation, as schematically illustrated in FIGS. 4 to 8. The polymerisation station 10 may be continuously loaded manually or automatically.

For example, in a finishing line 1 with the polymerisation station 10 arranged subsequently to a station S, the inlet 21 of the polymerisation station 10 may coincide with the outlet U of the preceding station S.

Suitably, there may be provided for a plurality of motor-driven rollers 29′ which may be configured so as to define the loading means 12, the advancement means 29 and the unloading means 13. Furthermore, the rollers 29′ arranged inside the support structure 20 may define the support plane 23.

During the irradiation step, the leather P may be substantially stationary or they may slide longitudinally along the axis X. On the other hand, the UV lamps 40 may be fixed or they may slide parallel or transversely to the axis X.

Even though not shown in the attached figures, the UV lamps 40 may be moveable differently, for example by rotating or varying the distance from the support plane 23.

FIG. 1A shows a single UV lamp 40 having a length substantially equal to the length of the support plane 23 so that the entire leather is irradiated simultaneously during use. The UV lamp 40 is arranged in a central longitudinal position, that is along the axis X and parallel to the support plane 23 so that the rays hit the leather in a substantially perpendicular manner.

FIG. 2A shows three UV lamps oriented transversely with respect to the axis X and moveable in a direction substantially parallel to the axis X. During irradiation, the leather may be fixed while the UV lamps 40 may be moveable.

On the other hand, in a further embodiment the leather may be moveable while the UV lamps 40 may be fixed.

FIG. 3A shows a plurality of UV lamps 40 arranged in succession so as to form a pair of rows of UV lamps arranged longitudinally along the axis X. The rows of UV lamps 40 are positioned so that the rays hit the leather substantially perpendicularly.

FIG. 4 shows a pair of UV lamps 40 arranged longitudinally along the axis X having a length substantially equal to the support plane 23 and arranged on opposite sides with respect to the axis X. The UV lamps are inclined with respect to the support plane 23 so as to form an angle of about 45° with the latter.

FIG. 5 shows a single UV lamp 40 arranged transversely with respect to the axis X. The leather P is mobile during the irradiation step.

FIG. 7 shows four UV lamps 40 arranged longitudinally in a manner substantially parallel to the axis X.

According to a particular embodiment of the invention, there may be provided for a device 100 for irradiating the leather P. In particular, the device 100 may be suitable to be displaced. For example, the device 100 may comprise handles 102 or hooks to facilitate the displacement thereof.

In light of the above, it is clear that the invention attains the pre-set objectives.

The invention is susceptible to numerous modifications and variants, all falling within the scope of protection of the attached claims. All details can be replaced by other technically equivalent elements, and the materials can be different depending on the technical needs, without departing from the scope of protection defined by the attached claims.

The invention claimed is:

1-30. (canceled)

31. A method of finishing a leather, the leather being a tanned or synthetic animal leather or a leather of animal origin, comprising the following steps:
providing the leather to be finished; and
irradiating the leather to be finished with UV rays,
wherein providing the leather comprises deposing, on the leather, a photopolymerizable composition which can be activated with UV rays,
wherein, when irradiating, the leather with the photopolymerizable composition, the step of irradiating being carried out subsequently to the step of deposing; and
wherein deposing comprises deposing, on the leather, one or more layers of the photopolymerizable composition in a scattered and non-point manner.

32. The method according to claim 31, wherein deposing, on the leather, the photopolymerizable composition comprises deposing, on the leather, the photopolymerizable composition in an amount comprised between 10 g/m² and 150 g/m².

33. The method according to claim 31, wherein the steps of providing and irradiating respectively comprise:
providing a first deposition of a first photopolymerizable composition which can be activated with the UV rays on the leather to be finished;
causing a first irradiation, with the UV rays, of the leather that includes the first photopolymerizable composition, so as to create a first layer of a first composition that is at least partially polymerized on the leather; and
providing a second deposition, on the leather that includes the first layer, of a second photopolymerizable composition which can be activated by the UV rays;
causing a second irradiation, with the UV rays, of the leather having the second photopolymerizable composition, so as to create, above the first layer, a second layer of the second photopolymerizable in an at least partially polymerized state.

34. The method according to claim 31, wherein deposing comprises deposing, on the leather, the one or more layers of the photopolymerizable composition of equal thickness.

35. The method according to claim 31, wherein deposing comprises deposing by spraying, roller, glazing, or buffer.

36. The method according to claim 35, wherein the step of spraying is carried out with at least one rotary turntable provided with at least 12 arms, each of the 12 arm including at least one spraying gun.

37. The method according to claim 31, wherein the step of deposing is carried out on the leather in dry condition.

38. The method according to claim 31, wherein the step of irradiating is carried out in a working chamber using at least one UV-ray generating device comprising a plurality of LEDs.

39. The method according to claim 38, further comprising a step of heating the working chamber to an operating temperature lower than 60° C.

40. The method according to claim 31, wherein the photopolymerizable composition is an aqueous solution or dispersion consisting of:
a photopolymerizable compound; and
a photoactivating agent;.

41. The method according to claim 31, wherein the photopolymerizable composition is an aqueous solution or dispersion consisting of:
a photopolymerizable compound; and
a photoactivating agent; and
one or more of: a crosslinking agent, a pigmenting agent, or a second additive.

42. A line for a continuous finishing of a leather, the leather being a tanned or synthetic animal leather or a leather of animal origin, the line comprising:
a deposition station for a deposition, on the leather, of a photopolymerizable composition which can be activated with UV rays;
a polymerization tunnel; and
an advancement system of the leather through the deposition station and the polymerization tunnel;
wherein the polymerization tunnel comprises therein at least one UV-ray generating device facing toward the advancement system, so that, during use, the UV rays that are emitted hit the leather to be finished, and
wherein the deposition station includes a non-point diffusion system of one or more layers of the photopolymerizable composition.

43. The line according to claim 42, wherein said non-point diffusion system is one or more of a sprayer, a roller, a glazing system, or a buffer.

44. The line according to claim 43, wherein the sprayer includes a spray booth having one or more guns.

45. The line according to claim 44, wherein the spray booth comprises a rotary turntable provided with at least 12 arms, each of the at least 12 arms including at least one spraying gun).

46. The line according to claim 42, wherein the at least one UV-ray generating device comprises a plurality of LEDs.
